(19) United States
(12) Patent Application Publication
(10) Pub. No.: US 2015/0290581 A1
(43) Pub. Date: Oct. 15, 2015

(54) CARBON DIOXIDE ABSORBING COMPOSITION INCLUDING ANTISOLVENT, AND METHOD AND APPARATUS FOR ABSORBING CARBON DIOXIDE USING THE SAME

(71) Applicant: KOREA INSTITUTE OF ENERGY RESEARCH, Daejeon (KR)

(72) Inventors: Taesung Jung, Daejeon (KR); Jong-Nam Kim, Daejeon (KR); Hee Tae Beum, Daejeon (KR); Sang-Sup Han, Daejeon (KR); Hyung Cheol Yoon, Daejeon (KR); Gyo Hee Kim, Daejeon (KR); Won Hi Hong, Daejeon (KR)

(21) Appl. No.: 14/398,500

(22) PCT Filed: Oct. 18, 2013
(86) PCT No.: PCT/KR2013/009327

§ 371 Date: Nov. 3, 2014

(30) Foreign Application Priority Data
Nov. 9, 2012 (KR) 10-2012-0126750

(51) Int. Cl. B01D 53/62; B01D 53/14; B01D 53/78; B01J 20/04

(52) U.S. Cl. CPC B01D 53/62; B01J 20/04; B01D 53/1475; B01D 53/78; B01D 2251/306; B01D 2252/202; B01D 2258/0283

(57) ABSTRACT

This invention relates to a carbon dioxide absorbing composition including an antisolvent, and to a method and apparatus for absorbing and regenerating carbon dioxide using the same, wherein in a process and apparatus for absorbing carbon dioxide from a gas mixture including carbon dioxide such as a flue gas of a coal-fired power plant and separating a bicarbonate slurry including a large amount of carbon dioxide so as to be regenerated at high pressure, a bicarbonate slurry production yield can be increased to thereby reduce the cost for sensible heat, latent heat and regeneration energy necessary for regeneration, cooling and heating of the carbon dioxide absorbing solution.

### BACKGROUND OF THE INVENTION

1. Field of the Invention

The present invention relates to a carbon dioxide absorbing composition including an antisolvent, and to a method and apparatus for absorbing carbon dioxide using the same. More particularly, the present invention relates to a carbon dioxide absorbing composition including an antisolvent and to a method and apparatus for absorbing carbon dioxide using the same, wherein in a process and apparatus for absorbing carbon dioxide from a gas mixture including carbon dioxide such as a flue gas of a coal-fired power plant and separating a bicarbonate slurry including a large amount of carbon dioxide so as to be regenerated at high pressure, a carbon dioxide absorbing composition prepared by mixing an aqueous antisolvent with a carbon dioxide absorbing inorganic salt solution containing an alkali metal is used, thus increasing a bicarbonate slurry production yield to thereby reduce the cost for sensible heat, latent heat and regeneration energy necessary for regeneration, cooling and heating of the carbon dioxide absorbing solution.

2. Description of the Related Art

Typically useful as a method of removing and recovering carbon dioxide from a gas mixture such as a flue gas using an absorbing solution is a process of bringing the absorbing solution into direct contact with the gas mixture so that the absorbent of the absorbing solution is coupled with carbon dioxide to thus remove carbon dioxide, from which a purified gas is obtained. In this process, when energy is supplied to the absorbing solution subjected to an absorbing process, carbon dioxide is separated and recovered from the absorbent, and the absorbing solution is regenerated so as to be capable of absorbing carbon dioxide again.

The absorbing solution for use in such a carbon dioxide absorbing process is exemplified by an amine- or alkali metal-based absorbing solution. Compared to an absorbing process using an amine, the carbon dioxide absorbing process using an alkali metal-based absorbing solution is advantageous in terms of the price of the absorbent and thermochemical safety. In particular, because this absorbing solution has low regeneration energy and is stable at high temperature and high pressure, it enables high-purity carbon dioxide to be regenerated at high pressure upon separating the absorbed carbon dioxide from the absorbing solution in a stripper. As such, the carbon dioxide thus produced should be transferred under the condition that it is compressed to a pressure of 50 bar or more to reduce its volume. However, the higher the number of stages of the compressor, the greater the energy consumption used in the process.

Therefore, in an absorbing process using an alkali metal-based absorbing solution able to produce carbon dioxide at a high pressure of at least 1˜20 bar, the unit cost and the operation cost for the compressor for compressing carbon dioxide may be considerably reduced. However, when the alkali metal-based absorbing solution is regenerated at high temperature, the temperature of the reboiler is increased compared to atmospheric pressure, and a large amount of absorbing solution has to be regenerated, undesirably increasing the consumption of energy such as sensible heat, latent heat of vaporization and reaction heat necessary for regeneration of the absorbent.

When the amount of the absorbing solution to be regenerated in a regenerator is decreased, energy necessary for regeneration may be reduced. Reducing the amount of an absorbing solution transferred to a regenerator includes an alkali metal bicarbonate crystallization method (International Publication No. WO/2011/130796 A1, and U.S. application Ser. No. 12/448,252). In this method, carbon dioxide is separated from the gas mixture including carbon dioxide in the absorber using an alkaline aqueous solution absorbent, and the separated absorbing solution is cooled to give a bicarbonate slurry solution, which is then separated into a slurry including a large amount of carbon dioxide and an absorbing solution including a small amount of carbon dioxide, followed by regenerating the slurry in the regenerator at high temperature to separate carbon dioxide, after which the remaining solution is mixed with the absorbing solution including a small amount of carbon dioxide and recovered to the absorber. However, this method is problematic because a large amount of absorbing solution including carbon dioxide discharged from the absorber should be cooled to low temperature, thus increasing the crystallization yield to thereby produce a bicarbonate slurry, and therefore, the unit cost and the operation cost of the heat exchanger and the cooling crystallizer are required due to problems of the cooling energy and the cooling rate. Furthermore, the absorbing solution at 10˜30° C. discharged from the crystallizer is transferred to an absorber operating at 60˜80° C. and the slurry at low temperature is transferred to a regenerator operating at 100˜250° C., undesirably increasing sensible heat energy due to the temperature difference.

### SUMMARY OF THE INVENTION

Accordingly, the present invention has been made keeping in mind the problems encountered in the related art, and an object of the present invention is to provide a carbon dioxide absorbing composition including an antisolvent, and a method and apparatus for absorbing and regenerating carbon dioxide using the same, wherein in a process and apparatus for absorbing carbon dioxide from a gas mixture including carbon dioxide such as a flue gas of a coal-fired power plant and separating a bicarbonate slurry including a large amount of carbon dioxide so as to be regenerated at high pressure, a bicarbonate slurry production yield may be increased to thereby reduce the cost for sensible heat, latent heat and regeneration energy necessary for regeneration, cooling and heating of the carbon dioxide absorbing solution.

In order to accomplish the above object, the present invention provides a carbon dioxide absorbing composition for use in a process including absorbing carbon dioxide from a gas mixture including carbon dioxide and separating a bicarbonate slurry including a large amount of carbon dioxide so as to be regenerated at high pressure, comprising: a carbon dioxide absorbing inorganic salt solution and an aqueous antisolvent.

The carbon dioxide absorbing inorganic salt solution may include a solution of a monovalent inorganic salt including any one selected from the group consisting of sodium, potassium, lithium, rubidium and cesium.

The monovalent inorganic salt concentration of the carbon dioxide absorbing inorganic salt solution may be 30 wt % when using an inorganic salt including sodium, 50 wt % when using an inorganic salt including potassium, 2 wt % when using an inorganic salt including lithium, 30 wt % when using an inorganic salt including rubidium, or 70 wt % when using an inorganic salt including cesium.

The aqueous antisolvent may be selected from the group consisting of methanol, ethanol, propanol, ethyleneglycol, propyleneglycol, diethyleneglycol, triethyleneglycol, polyethyleneglycol, N-methylpyrrolidone, propylenecarbonate, ethylenecarbonate and mixtures thereof.

The aqueous antisolvent may be contained in an amount of 30 wt % or less but exceeding zero based on a total weight of the carbon dioxide absorbing composition.

In a preferred embodiment of the present invention, the carbon dioxide absorbing composition of the invention may further comprise any one or a mixture of two or more selected from the group consisting of an absorption rate enhancer, an antioxidant and a corrosion inhibitor, as necessary.

In addition, the present invention provides a method of absorbing and regenerating carbon dioxide, comprising: bringing the carbon dioxide absorbing composition as above into contact with a gas mixture including carbon dioxide to thus absorb carbon dioxide; cooling the carbon dioxide absorbing composition having absorbed carbon dioxide, thus forming a bicarbonate slurry; and separating a solid slurry and a liquid absorbing solution including an aqueous antisolvent from the bicarbonate slurry, and then separating and recovering the antisolvent from the absorbing solution while heating the solid slurry to high temperature, thus separating carbon dioxide.

In addition, the present invention provides an apparatus for absorbing and regenerating carbon dioxide, comprising: an absorber for selectively absorbing carbon dioxide from a flue gas using the carbon dioxide absorbing composition as above; a crystallizer for cooling the carbon dioxide absorbing composition having absorbed carbon dioxide using a cooler or a heat exchanger to form a bicarbonate slurry; a filter for separating a solid slurry and a liquid absorbing solution including an aqueous antisolvent from the bicarbonate slurry; a liquid-liquid separator for separating the antisolvent from the aqueous solution; and a regenerator for heating the solid slurry to high temperature to separate carbon dioxide.

According to the present invention, in a process and apparatus for absorbing carbon dioxide from a gas mixture including carbon dioxide such as a flue gas of a coal-fired power plant and separating a bicarbonate slurry including a large amount of carbon dioxide so as to be regenerated at high pressure, a carbon dioxide absorbing composition obtained by mixing an aqueous antisolvent with a carbon dioxide absorbing inorganic salt solution containing an alkali metal is used, thus increasing a bicarbonate slurry production yield and separating and regenerating only a solid slurry to thereby reduce the cost for sensible heat, latent heat and regeneration energy necessary for regeneration, cooling and heating of the carbon dioxide absorbing solution.

### BRIEF DESCRIPTION OF THE DRAWINGS

The above and other objects, features and advantages of the present invention will be more clearly understood from the following detailed description taken in conjunction with the accompanying drawings, in which:

FIG. 1 schematically illustrates an apparatus and process for absorbing and regenerating carbon dioxide using a carbon dioxide absorbing composition including an antisolvent according to an embodiment of the present invention;

FIG. 2 schematically illustrates an apparatus and process for absorbing and regenerating carbon dioxide using a carbon dioxide absorbing composition including an antisolvent according to another embodiment of the present invention;

FIG. 3A illustrates the phase-separation state after crystallization of the carbon dioxide absorbing composition including the antisolvent in Test Example 1 according to the present invention;

FIG. 3B illustrates the results of measurement of the phase-separated bicarbonate slurry and reference material using an IR spectrophotometer;

FIG. 4 illustrates the bicarbonate crystal production yield depending on the kind of antisolvent in Test Example 1 according to the present invention; and

FIG. 5 illustrates the bicarbonate crystal production yield depending on the concentration of antisolvent in Test Example 1 according to the present invention.

### DESCRIPTION OF SPECIFIC EMBODIMENTS

Hereinafter, a detailed description will be given of the present invention.

According to the present invention, a carbon dioxide absorbing composition is used in a process including absorbing carbon dioxide from a gas mixture including carbon dioxide and separating a bicarbonate slurry including a large amount of carbon dioxide so as to be regenerated at high pressure, and includes a carbon dioxide absorbing inorganic salt solution and an aqueous antisolvent.

As used herein, the term “carbon dioxide absorbing inorganic salt solution” refers to an aqueous solution of a monovalent inorganic salt including sodium, potassium, lithium, rubidium or cesium capable of absorbing carbon dioxide.

The inorganic salt concentration of the carbon dioxide absorbing inorganic salt solution may be 30 wt % when using an inorganic salt including sodium, 50 wt % when using an inorganic salt including potassium, 2 wt % when using an inorganic salt including lithium, 30 wt % when using an inorganic salt including rubidium, or 70 wt % when using an inorganic salt including cesium. As the inorganic salt concentration is higher, the amount of absorbed carbon dioxide may be increased. However, if the inorganic salt concentration is excessively high, supersaturation of the carbonate is caused in the absorbing solution transferred to the absorber, whereby a solid slurry is created in the absorber and may thus negatively affect the material transfer. Furthermore, if the inorganic salt concentration exceeds the above upper limit, the amount of water of the absorbing solution is low, and thus gas-liquid material transfer may become inefficient and it is difficult to remove the absorption heat.

The carbon dioxide absorbing composition according to the present invention includes a carbon dioxide absorbing inorganic salt solution and an aqueous antisolvent.

The use of such a carbon dioxide absorbing composition including the carbon dioxide absorbing inorganic salt solution and the aqueous antisolvent may result in an increased bicarbonate production yield, thus forming a solid slurry without a need to remarkably lower the cooling temperature, from which high-purity carbon dioxide may be absorbed and recovered.

Useful in the present invention, the aqueous antisolvent is selected from among polar protic solvents including alcohols and glycols, such as methanol, ethanol, propanol, ethyleneglycol, propyleneglycol, diethyleneglycol, triethyleneglycol and polyethyleneglycol, and polar aprotic solvents such as N-methylpyrrolidone, propylenecarbonate, ethylenecarbonate, and mixtures thereof. Particularly useful is either ethanol or N-methylpyrrolidone to ensure a desired bicarbonate production yield.

The aqueous antisolvent may be added in an amount of 30 wt % or less but exceeding zero based on the total weight of the carbon dioxide absorbing composition. Because the aqueous antisolvent functions to increase supersaturation, it is preferably added in a large amount. However, if this antisolvent is added in an amount exceeding the upper limit, the amount of the carbon dioxide absorbing solution separated from the antisolvent may decrease, which may thus negatively affect the absorption of carbon dioxide in the absorber.

The carbon dioxide absorbing composition according to the present invention may further include any one or a mixture of two or more selected from the group consisting of an absorption rate enhancer, an antioxidant and a corrosion inhibitor, as necessary.

According to the present invention, examples of the absorption rate enhancer contained in the carbon dioxide absorbing composition may include, but are not limited to, piperazine and piperazine derivatives, amino acid and borates, and examples of the antioxidant and the corrosion inhibitor contained therein may include, but are not limited to, vanadium oxide, antimony oxide, potassium dichromate, nickel, iron, copper, chromium ions, 2-aminothiophenol, and 1-hydroxyethylidene-1,1-diphosphonic acid.

In addition, the present invention addresses a method of absorbing and regenerating carbon dioxide, comprising: bringing the carbon dioxide absorbing composition into contact with a gas mixture including carbon dioxide to thus absorb carbon dioxide; cooling the carbon dioxide absorbing composition having absorbed carbon dioxide, thus forming a bicarbonate slurry; and separating a solid slurry and a liquid absorbing solution including an antisolvent from the bicarbonate slurry, and then separating and recovering the antisolvent from the absorbing solution while heating the solid slurry to high temperature, thus separating carbon dioxide.

Below is a description of the method of absorbing and regenerating carbon dioxide according to the present invention, with reference to the drawings.

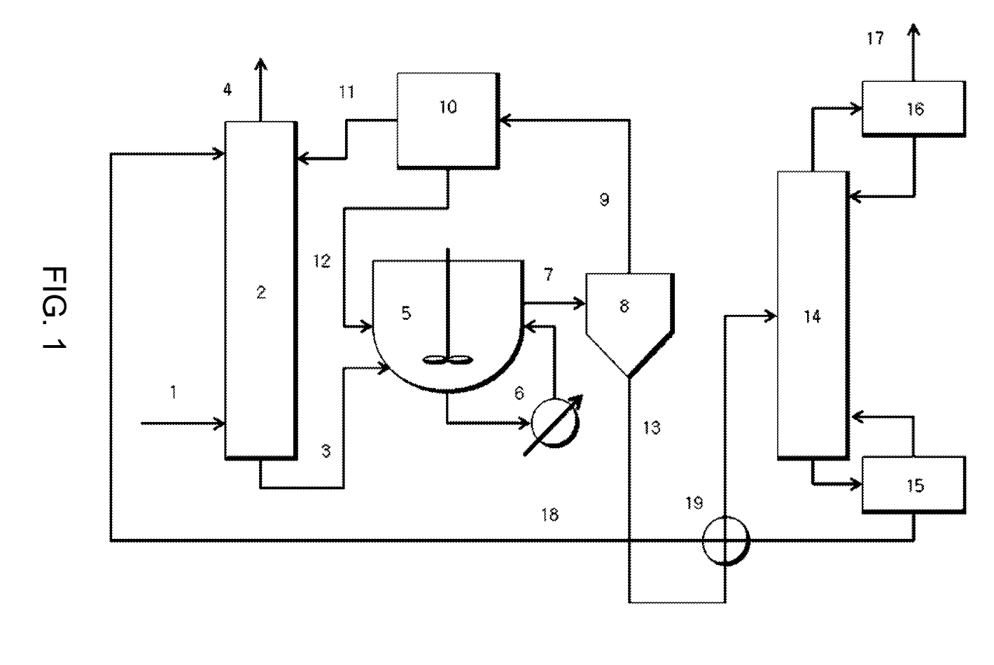

FIG. 1 schematically illustrates the apparatus and process for crystallizing the bicarbonate slurry by means of the aqueous antisolvent of the carbon dioxide absorbing composition according to the present invention and regenerating the separated solid slurry to recover carbon dioxide.

As illustrated in FIG. 1, the apparatus for absorbing and regenerating carbon dioxide according to the present invention comprises: an absorber 2 for selectively absorbing carbon dioxide from a flue gas 1 using a carbon dioxide absorbing composition 11 according to the present invention; a crystallizer 5 for cooling a carbon dioxide absorbing solution 3 having absorbed carbon dioxide using a cooler or a heat exchanger 6 to form a bicarbonate slurry; a filter 8 for separating a solid slurry 13 from the bicarbonate slurry 7; a regenerator 14 for heating the solid slurry 13 to high temperature to separate carbon dioxide; a reboiler 15 provided under the regenerator 14; and a condenser 16 provided above the regenerator 14 to condense water.

Specifically, the carbon dioxide absorbing composition 11 is brought into contact with the gas mixture including carbon dioxide, for example, the flue gas 1 to thus absorb carbon dioxide.

As the carbon dioxide absorbing composition 11 is sprayed from the top of the absorber using a nozzle at 60˜80° C. and atmospheric pressure, the absorber 2 absorbs carbon dioxide and the carbon dioxide absorbing composition 3 having absorbed carbon dioxide is discharged from the bottom of the absorber 2. To increase the material transfer due to gas-liquid contact, a filler may be provided in the absorber 2, or the carbon dioxide absorbing composition 11 may be sprayed using a spray nozzle, but no limitation is imposed on the spraying process.

Subsequently, the carbon dioxide absorbing composition 3 having absorbed carbon dioxide is cooled, thus forming the bicarbonate slurry.

The carbon dioxide absorbing composition 3 having absorbed carbon dioxide is transferred to the crystallizer 5 and cooled to 10˜50° C. using the cooler or the heat exchanger 6 to thus cause supersaturation of a bicarbonate crystal. The cooler or the heat exchanger 6 may be located inside or outside the crystallizer 5, and a stirrer may be further provided to increase heat transfer efficiency of the carbon dioxide absorbing composition 3. Useful is a crystallizer that is able to increase the size of slurry particles by separating small particles and removing them through heating or in which there is flow therein, but the kind of crystallizer is not limited.

As such, since the bicarbonate crystal production yield may be increased by the aqueous antisolvent contained in the carbon dioxide absorbing composition 11, there is no need to remarkably lower the cooling temperature, thus forming a bicarbonate slurry solution. The bicarbonate slurry solution is separated into the solid slurry 13 containing carbon dioxide in a relatively large amount and the liquid absorbing solution 9 including the antisolvent containing carbon dioxide in a small amount, by means of the filter 8. Examples of the filter 8 may include a filter, a cyclone, and a settling tank, each for separating a solid and a liquid from each other.

After separation of the solid slurry 13 and the liquid absorbing solution 9 including the antisolvent from the bicarbonate slurry, the solid slurry 13 is heated to high temperature, so that carbon dioxide is separated.

The separated solid slurry 13 is transferred to the regenerator 14 and further separated into carbon dioxide, water and a carbon dioxide absorbing inorganic salt solution at 100˜250° C. and 1˜20 bar. The regenerator 14 includes a reboiler 15 thereunder to supply steam so that the slurry is decomposed, and also includes a condenser 16 thereabove so that water to be evaporated is condensed and then refluxed to the regenerator 14, and thereby high-purity carbon dioxide 17 may be recovered. The regenerator 14 may be provided in the form of a column including a filler therein or a stirring pressure reaction tank, but is not necessarily limited thereto. The regenerated absorbing solution 18 recovered from the regenerator 14 includes a small amount of carbon dioxide, and is circulated to the absorber 2 via a heat exchanger 19. The regenerated absorbing solution 18 having no carbon dioxide is recovered to the absorber 2 from the bottom of the regenerator 14. The carbon dioxide discharged from the top of the regenerator 14 is dewatered using the condenser 16, and water is refluxed to the regenerator 14 and the regenerated high-purity carbon dioxide 17 is recovered as a product.

Also, subjecting the liquid absorbing solution separated from the bicarbonate slurry to liquid-liquid separation to separate the aqueous antisolvent may be further performed.

Thus, a liquid-liquid separator 10 may be further provided to selectively separate the antisolvent from the liquid absorbing solution 9 including the antisolvent separated by the filter 8. Furthermore, the antisolvent 12 is separated again from the liquid absorbing solution 9 by the filter and then supplied to the crystallizer 5, and the separated liquid absorbing solution 9 may be fed into the absorber 2.

Meanwhile, heat may be recovered from the low-temperature liquid absorbing solution 9 discharged from the filter 8 and the carbon dioxide absorbing composition 3 having absorbed carbon dioxide discharged from the absorber 2, by use of the heat exchanger, and the heat exchanger may be additionally provided to increase heat exchange efficiency.

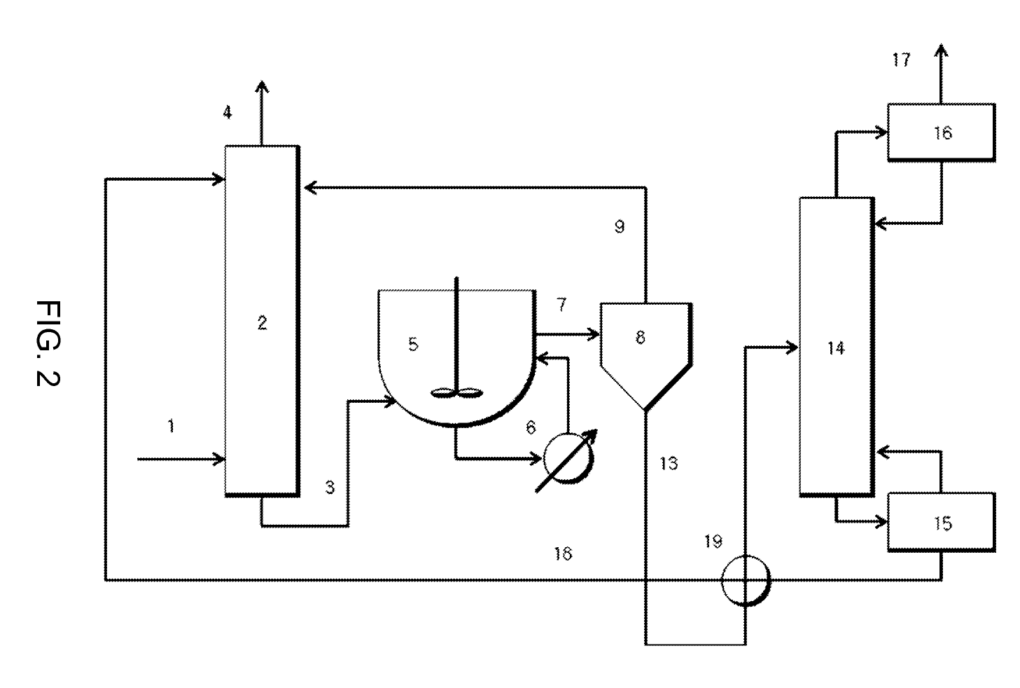

FIG. 2 illustrates circulating the liquid absorbing solution 9 including the antisolvent to the absorber 2, without addition of the liquid-liquid separator 10. When the antisolvent has low vapor pressure at 60˜80° C. and atmospheric pressure to thus exhibit low solvent evaporation, the antisolvent may be added to the liquid absorbing solution 9, and thus the resulting solution may be utilized as the carbon dioxide absorbing composition

### Test Example 1

### Crystallization of CO₂ Absorbing Composition Including Antisolvent

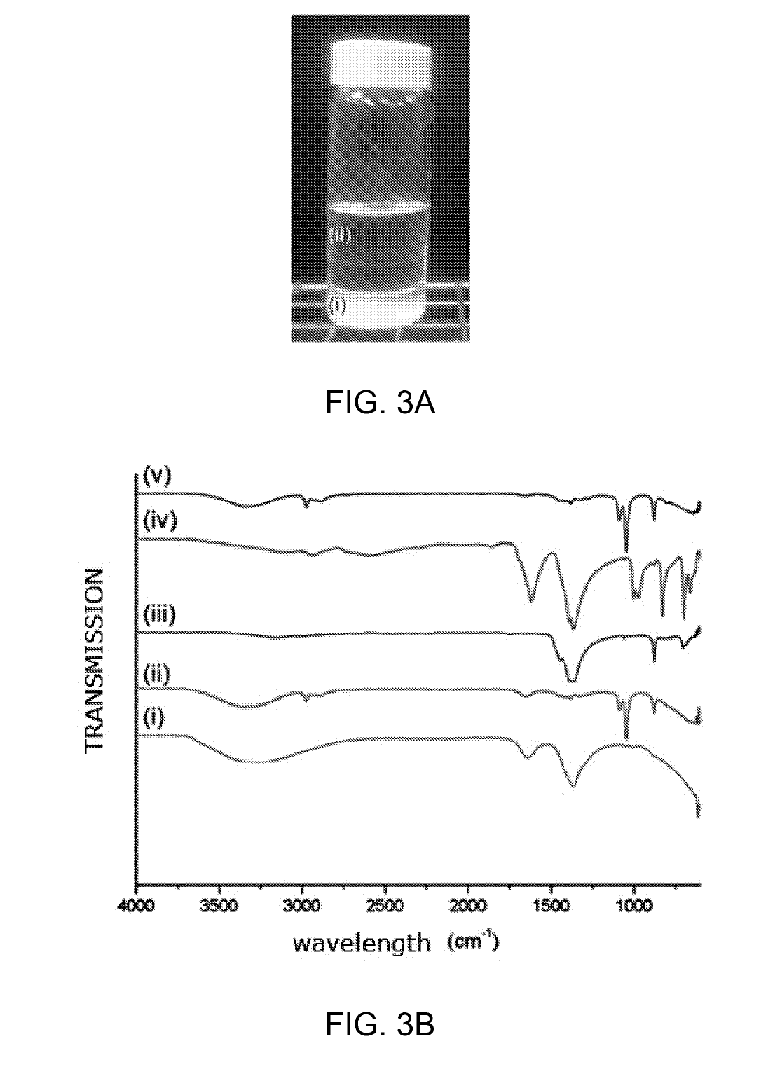

9 g of a potassium bicarbonate solution saturated at 25° C. was mixed with 1 g of ethanol, placed in a closed vessel, heated to 70° C. and then cooled to 25° C. FIG. 3 illustrates the mixed solution after the cooling process, wherein it is phase-separated into a transparent supernatant at the upper portion of (ii) and a precipitated slurry solution at the lower portion of (i). When the slurry solution of (i) was measured using an IR spectrophotometer, it had the same shape as the reference material potassium bicarbonate (iv) rather than the reference material potassium carbonate (iii). The results of measurement of the upper portion of (ii) agreed with those of the reference material pure ethanol (v). The antisolvent was not contained in the potassium bicarbonate solution but was easily phase-separated. The slurry produced by the cooling crystallization had a crystal size of about 500 μm and was thus easily precipitated, consequently facilitating solid-liquid separation.

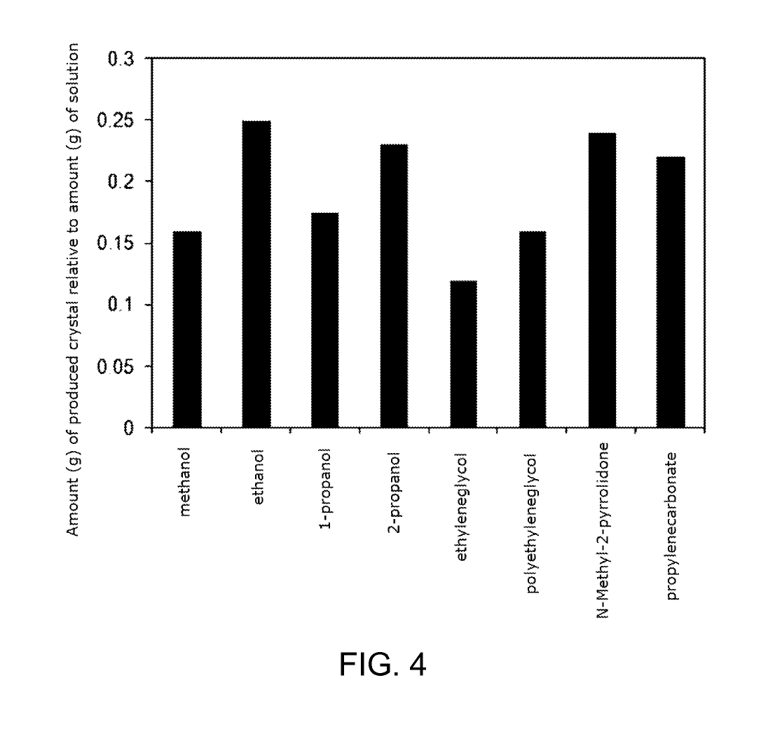

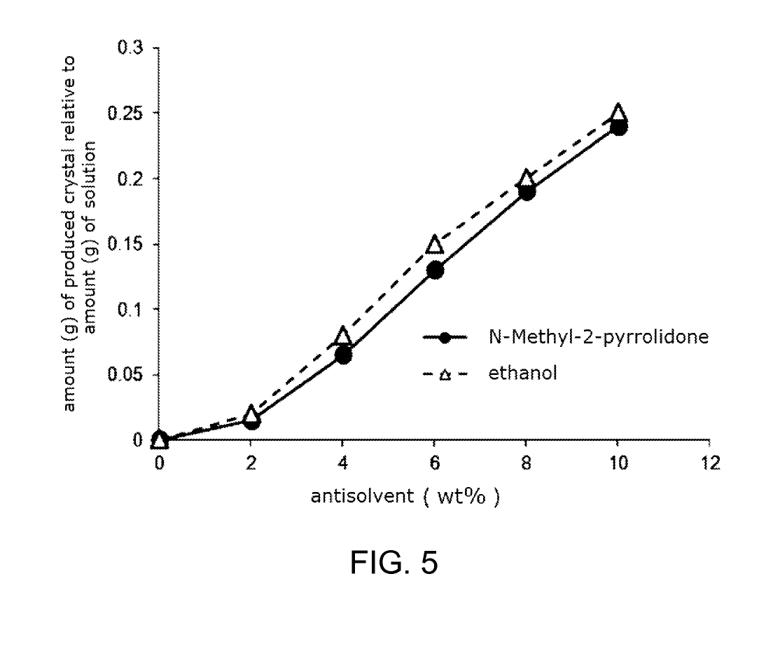

FIG. 4 illustrates the amount (g) of the produced crystal relative to the amount (g) of the solution when using the aqueous antisolvent, such as methanol, ethanol, 1-propanol, 2-propanol, ethyleneglycol, polyethyleneglycol, N-methylpyrrolidone and propylenecarbonate. The bicarbonate crystal production yield was higher in the presence of the antisolvent than in the absence of the antisolvent. Especially, the use of ethanol or N-methylpyrrolidone resulted in high bicarbonate crystal yield. FIG. 5 illustrates an increase in the amount of precipitated crystal in proportion to an increase in the concentration of ethanol or N-methylpyrrolidone. Thereby, when the antisolvent is used, the bicarbonate crystal yield can be confirmed to increase.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A carbon dioxide absorbing composition for use in a process including absorbing carbon dioxide from a gas mixture including carbon dioxide and separating a bicarbonate slurry including a large amount of carbon dioxide so as to be regenerated at a high pressure, comprising:
a carbon dioxide absorbing inorganic salt solution and an aqueous antisolvent wherein the aqueous antisolvent is a polar protic solvent.

2. The composition of claim 1, wherein the carbon dioxide absorbing inorganic salt solution is a solution of a monovalent inorganic salt including any one selected from the group consisting of sodium, potassium, lithium, rubidium and cesium.

3. The composition of claim 1, wherein the carbon dioxide absorbing inorganic salt solution is a potassium solution.

4. The composition of claim 1, wherein an inorganic salt concentration of the carbon dioxide absorbing inorganic salt solution is 30 wt % when using an inorganic salt including sodium, 50 wt % when using an inorganic salt including potassium, 2 wt % when using an inorganic salt including lithium, 30 wt % when using an inorganic salt including rubidium, or 70 wt % when using an inorganic salt including cesium.

5. The composition of claim 1, wherein the aqueous antisolvent is selected from the group consisting of methanol, ethanol, propanol, ethyleneglycol, propyleneglycol, diethyleneglycol, triethyleneglycol, polyethyleneglycol, N-methylpyrrolidone, propylenecarbonate, ethylenecarbonate and mixtures thereof.

6. The composition of claim 5, wherein the aqueous antisolvent is ethanol or N-methylpyrrolidone.

7. The composition of claim 5, wherein the aqueous antisolvent is contained in an amount of 30 wt % or less but exceeding zero based on a total weight of the carbon dioxide absorbing composition.

8. The composition of claim 1, further comprising any one or a mixture of two or more selected from the group consisting of an absorption rate enhancer, an antioxidant and a corrosion inhibitor.

9. A method of absorbing and regenerating carbon dioxide, comprising:
bringing the carbon dioxide absorbing composition of claim 1 into contact with a gas mixture including carbon dioxide to thus absorb carbon dioxide;
cooling the carbon dioxide absorbing composition having absorbed carbon dioxide, thus forming a bicarbonate slurry; and
separating a solid slurry and a liquid absorbing solution including an aqueous antisolvent from the bicarbonate slurry, and then separating and recovering the antisolvent from the absorbing solution while heating the solid slurry to a high temperature, thus separating carbon dioxide.

10. The method of claim 9, wherein bringing the carbon dioxide absorbing composition into contact with the gas mixture including carbon dioxide is performed by spraying the carbon dioxide absorbing composition to the gas mixture including carbon dioxide at 60˜80° C. and atmospheric pressure.

11. The method of claim 9, wherein the carbon dioxide absorbing composition having absorbed carbon dioxide is cooled to 10˜50° C., thus forming the bicarbonate slurry.

12. The method of claim 9, wherein the solid slurry separated from the bicarbonate slurry is heated at 100˜250° C. and 1˜20 bar, thus separating carbon dioxide.

13. The method of claim 9, further comprising subjecting the liquid absorbing solution including the antisolvent separated from the bicarbonate slurry to liquid-liquid separation, thus separating the aqueous antisolvent.

14. An apparatus for absorbing and regenerating carbon dioxide, comprising:
an absorber 2 for selectively absorbing carbon dioxide from a flue gas using the carbon dioxide absorbing composition of claim 1;
a crystallizer 5 for cooling the carbon dioxide absorbing composition having absorbed carbon dioxide using a cooler or a heat exchanger to form a bicarbonate slurry;
a filter 8 for separating a solid slurry and a liquid absorbing solution including an aqueous antisolvent from the bicarbonate slurry; and
a regenerator 14 for heating the solid slurry to a high temperature to separate carbon dioxide.

15. The apparatus of claim 14, further comprising a liquid-liquid separator 10 for separating the aqueous antisolvent from the liquid absorbing solution including the antisolvent.

16. The apparatus of claim 14, wherein the regenerator 14 comprises a reboiler 15 for decomposing the solid slurry and a condenser 16 for separating water and carbon dioxide from each other.
